(19) United States
(12) Patent Application Publication
(10) Pub. No.: US 2014/0041749 A1
(43) Pub. Date: Feb. 13, 2014

(54) Fuel Recovery System and Method

(71) Applicant: Chris Kightly, San Jose, CA (US)

(72) Inventor: Chris Kightly, San Jose, CA (US)

(21) Appl. No.: 14/059,377

(22) Filed: Oct. 21, 2013

Related U.S. Application Data
(63) Continuation-in-part of application No. 12/860,677, filed on Aug. 20, 2010, now Pat. No. 8,561,658.

(51) Int. Cl. B67D 7/06

(52) U.S. Cl. CPC B67D 7/06
USPC 141/1; 141/330

(57) ABSTRACT

A residual fuel removal system from the fuel tanks of vehicles raised upon a automotive lift or driven over a automotive work pit. The device features a power driven translating member for piercing the fuel tank. The member has an axial passage for communication of fluid from the distal end or a spear or sealing component, to a reservoir. The hole produced by a piercing spear tip can be adapted to allow the insertion of a bung (where required). The piercing member is surrounded by a funneling basin to direct all exiting liquid to a through the axial passage to the reservoir. The device can be engaged upon a rolling support or on an arm of a pivoting wall mounted support.

This application is a continuation-in-part of U.S. patent application Ser. No. 12/860,677 filed on Aug. 20, 2010 (currently allowed) all incorporated herein in entirety by this reference.

### BACKGROUND OF THE INVENTION

1. Field of the Invention

This disclosed device relates to reclaimation of liquid fuels such as gasoline or diesel fuel and oil. More particularly it relates to a method and device for recapturing fuel from the fuel tanks of vehicles undergoing the salvaging process in vehicle salvage yards. In particular, it relates to a device providing a safe and efficient reclaimation of liquid fuels from mounted fuel tanks of vehicles being salvaged.

2. Prior Art

With the advent of the automobile, an industry was soon thereafter initiated to salvage parts and metals and other materials and components from motor vehicles. Every year there are thousand of vehicles driven, hauled, or dragged to salvage yards, some still with usable parts and surprisingly unused fuel as well.

Salvage yards modernly employ elaborate systems to keep track of individual vehicles as well as all usable parts in vehicles in their inventory to maximize profits on these individual parts. Unbroken windshields, exhaust systems, light assemblies, and transmissions are just a few examples of recyclable and reusable parts taken from junked vehicles.

Motor vehicle salvage is growing due to the need for newer and cleaner burning fuels and more efficient engines and means of travel. As a consequence, more and more, older vehicles are being scrapped and salvaged at salvage yards.

Most, if not all of these vehicles, upon arrival at a conventional wrecking yard or salvage facility, have tanks containing petroleum fuels such as gasoline and diesel. In past years, the contents of such tanks were simply dumped onto the ground causing extensive soil and groundwater pollution. Modernly, this type of behavior is highly illegal as in previous decades many acres of land have had to be excavated to remove harmful petroleum products from the soil.

Modern salvage yard owners, being attuned to environmental aspects and legal requirements, have made great strides in preventing intentional and accidental spillage of fuel tank contents onto the soil. In their efforts to maintain a clean environment, and to abide by environmental regulations, large quantities of fuels have been required for collection from the vehicles in such salvage yards. Due to stringent laws and regulations on pollution and fire hazards, collection of these liquid fuels is one of the first items of business when a new salvage vehicle reaches the salvage yard. Any vehicle with a tank is conventionally inspected for fuel contents which if found, must be removed so as to prevent any accidental spillage and fire hazards. This is done generally before a vehicle is placed into inventory in the yard with others.

It has been ascertained, that the environmental requirements can actually be profitable if handled to collect usable fuels such as gasoline and diesel in quantities that may be recycled. In today's market of high gas and oil prices and need for alternative fuels, methods of preventing fuel waste and pollution have evolved from being important to being profitable as well.

For salvage yards though, the primary profit comes from the resale of car parts and not necessarily the left over gas and oil. Since labor is the largest cost for most salvagers, minimizing the required labor to remove fuels and abide by environmental regulations, helps maximize their profits on the parts themselves.

Previous systems have not provided any means or method to efficiently extract fuels from tanks, prior to storage, crushing, or disassembly of vehicles and to concurrently avoid spills and chance of fire, and allow for the sealing of drained tanks if required by law. As a consequence, there is no widely used system or device adapted specifically to remove unused gas from gas tanks of salvaged vehicles efficiently and in a fashion where it may be easily recycled. Many salvage yards still remove the tank by hand, using wrenches to remove them and a screwdriver for puncturing with a hammer. Collection of fuel is by hand and employs a bucket or drum. This is both inefficient and labor intensively costly.

Other than removal by hand, using costly labor, it is known that the siphon principal can be employed with a simple tube set in the fuel tank to effectively remove fuel. But it can be noted that such a process is often not employed easily on the first attempt and the chance of ingesting harmful chemicals is greatly abundant. Also, once the siphon has started, often fluid is lost when transferring from the users mouth or a pump, to a receptacle. Therefor this method is not only undesirable, in an environmental point of view but also from a salvage yard owner's point of view, due to the danger imposed upon it's employee.

It has also been known that the dangers of a siphon can be averted by the use of a pump system. U.S. Pat. No. 1,582,399 to Helander teaches of a manually operated pump in which siphonic flow is started. Although the dangers of self siphoning have been averted there still requires the labor of pumping. Also, siphoning is mainly done from the side of the vehicle through the gas fill door therefor any other work to be done underneath the car must be halted.

Salvaged vehicles do not need to retain an intact fuel tank (unless of course the fuel tank is to be salvaged) so the use of non-intrusive methods of fluid removal only add more work and in turn costs. A punctured hole can obtain the same results. Since much of the salvage work done in a salvage yard is completed when the vehicle is raised on a automotive lift or driven over an automotive work pit where ample space is provided, it is economically more viable to remove the fuel when the vehicle is in this arrangement to allow for other work to be done during the draining period.

U.S. Pat. No. 5,375,862 to Sirianno teaches a device for receiving fluids from vehicles with employment of a funnel engaged upon a rolling platform where a receptacle is placed under to collect fluid and later be removed. This device does not employ any method of piercing a tank to retrieve the fluid of a completely enclosed tank, and instead relies upon a draining plug (which modern tanks do not employ), or requires the user to create a hole such as with a hammer and screwdriver. Concurrently, they must carefully place the collection device under the spewing hole they create. Although the device includes a manually operated height adjustment screw, this method is neither fast nor convenient for large changes in height.

U.S. Pat. No. 4,230,002 to Skidmore teaches a two in one oil pan plug remover and funnel for used oil collection. This device, similar to Sirianno requires the presence of a removable plug which many modern vehicles lack. Neither does Skidmore provide any method of translating a collection funnel to varying heights to capture fuel.

As such, there is a continuing unmet need for an improved device and system of easily engaged components, which will allow for the removal of fluids, from fuel and other tanks with lacking drainage apertures, such as from a salvaged vehicle fuel tank, in an efficient and safe manner. Such a device should employ minimal labor to reduce costs, as well as minimal time to reduce labor. Further, such a device should provide for concurrent opening of the tank at a lower end and total collection of drained fluids, so as to avoid spilling. Finally, such a system should provide a means to route the collected fuels from small tanks to a reservoir where it may be collected and recycled by larger transporting tankers.

### SUMMARY OF INVENTION

The device herein provides a solution to the above noted shortcomings in the prior art. The applicant's device provides a user with a manner to drain and recapture fuel from a vehicle's fuel tank in a safe and efficient manner and in various embodiments may be portable or permanently mounted depending on the intended use. The device features a spear tip that is engageable upon a hydraulically or other powered, vertically translating shaft member, having an axial passage therethrough for communicating fluids from the tank, to a reservoir. If the spear is employed the translating shaft is generally of a smaller diameter than the spear. Other modes of communicating sufficient force to the translating member for a piercing of the fuel tank could include a spring loading apparatus with trigger, or a large lever and geared component operatively engaged with the translating member to force it through the wall of the fuel tank.

In operation, as the hydraulicly or otherwise powered translating member, is forced upward and its distal end or the spear, at its tip, is punched through the bottom wall of an automobile fuel tank. Just a few of other components employable to power the translating member through a fuel tank wall as will be surmised by those skilled in the art, include a solenoid powered by electricity, a triggered spring loaded component, or a lever and geared drive engaged with the translating member. As such a powered means to translate the member a force sufficient to puncture the wall of a gas tank can include one or a combination of a group of powered components including a pump communicating fluid under pressure to a cylinder, an electrically powered solenoid, a user triggerable spring loaded component, and a geared component achieving mechanical advantage with gearing between the lever and the translating member. Any other means for powering the translation of the member at a force to pierce the tank wall as would occur to those skilled in the art is anticipated within the scope of the claims of this application.

When the translating member and/or spear is pushed through the wall forming the fuel tank bottom, and the underlying translating member of smaller diameter enters the aperture if formed by the spear, it allows a flow of fluid in the gap between the formed aperture and the translating member. Fluid flow may alternatively communicate to the reservoir through a hollow axial chamber running to the distal end of the translating member. The fluid, which in this case is gas or diesel fuel, flows through the punched hole and any other drainage flows into a fluid receiver shown as bowl or funnel-like component directly below it.

Fluid reaching the fluid receiver is thereafter communicated to an outlet near the bottom of the fluid receiver, where a hose that leads to a fluid reservoir can be attached. The fluid receiver funnel can be immovably engaged upon a ridged member forming the exterior of the structure supporting the translating member such as the hollow translating shaft member itself. Alternatively, it may be coupled coaxially with the shaft member and ascend and descend with it, or at different times depending on the coaxial shaft configuration.

If ascending concurrently, the fluid receiving funnel will be positioned on the shaft member in a position behind the distal end or spear during travel, to allow full penetration of the translating shaft or spear into the fuel tank without contacting the leading edge of the fluid receiver into the tank as well. The leading edge of the fluid receiver may be flexible or have a seal to help maintain fluid therein during draining. Fluid flowing into the fluid receiver, is communicated to a storage tank using a conduit therebetween.

In another preferred mode of the disclosed device the aforementioned components are engaged upon a portable rolling cart or platform. This allows the user to easily position the device under a raised vehicle to pierce and sealably engage with the gas tank, as well as quickly remove the device after the fuel is recaptured. This allows for the use of one such device in a work space where multiple vehicles need to be worked on and the sharing of equipment is cost effective.

Often, vehicle garages, wrecking yards, and work/staging areas can be quite cluttered and adding another piece of equipment just continues to build this clutter. Another mode of the disclosed device employ a wall mounted system which is moveable along with the power or hydraulics, shaft and spear, and fluid receiver funnel housing is employed on a wall mounted system. Though this mode of the system limits the range of use of the device within a garage area, the space saving aspect may prove more desirable.

With respect to the above description, it is to be understood that the invention is not limited in its application to the details of operation of the fuel recovery system nor the arrangement of the components or steps in the method set forth above or in the following descriptions or in the illustrations in the drawings. The various methods of implementation and operation of the disclosed fuel recovery system herein, are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefor, those skilled in the art will appreciate that the conception upon which this disclosure is based may readily be utilized as a basis for designing similar fuel recovery systems for carrying out the several purposes of the present invention. Therefor, the objects and claims herein should be regarded as including such equivalent constructions, steps, and methodology insofar as they do not depart from the spirit and scope of the present invention.

Further objectives of this invention will be brought out in the following part of the specification wherein detailed description is for the purpose of fully disclosing the invention without placing limitations thereon.

It is the object of this invention to provide the user with a safe and efficient manner for removing fuel from salvaged vehicles or vehicles of the like in a manner that is easily employed during the normal salvage operations required upon the vehicle.

### BRIEF DESCRIPTION OF THE FIGURES

FIG. 1 is a view of the device herein disclosed mode of the present invention on a rolling cart system ready for employment to puncture a fuel tank.

FIG. 1a shows the pointed tip at a distal end of a translating member configured for puncturing the bottom wall of a vehicle fuel tank.

FIG. 2 illustrates the device translated to puncture a fuel tank with a coaxial funnel component in sealed communication with the exterior of the tank and collecting drainage.

FIG. 3 depicts a perspective overhead view of the device showing the translating member engageable to the spear and the funnel component adapted to collect drainage and seal against the tank.

FIG. 4 shows a close up view of the funnel component having a translatable member exiting within which is configured to engage the spear of FIG. 1a.

FIG. 5 illustrates the device engaged to a swinging arm system rather than the cart whereby drainage of collected fuel is directed along the arm to a storage reservoir.

FIG. 6 depicts the device of FIG. 1 showing independent translation of funnel component as a means to form a seal with the exterior wall surface of the fuel tank prior to translation of the member and puncture of the tank.

FIG. 7 depicts the device of FIG. 6 showing translation of the shaft member through the tank wall to position the axial passage into a communication with the interior of the fuel tank.

FIG. 8 shows a spring loaded component employable to force the shaft member through the fuel tank wall.

FIG. 9 depicts a geared component employable to impart the driving force to the shaft member and power it through the tank wall.

### DETAILED DESCRIPTION OF THE PREFERRED EMBODIMENTS OF THE INVENTION

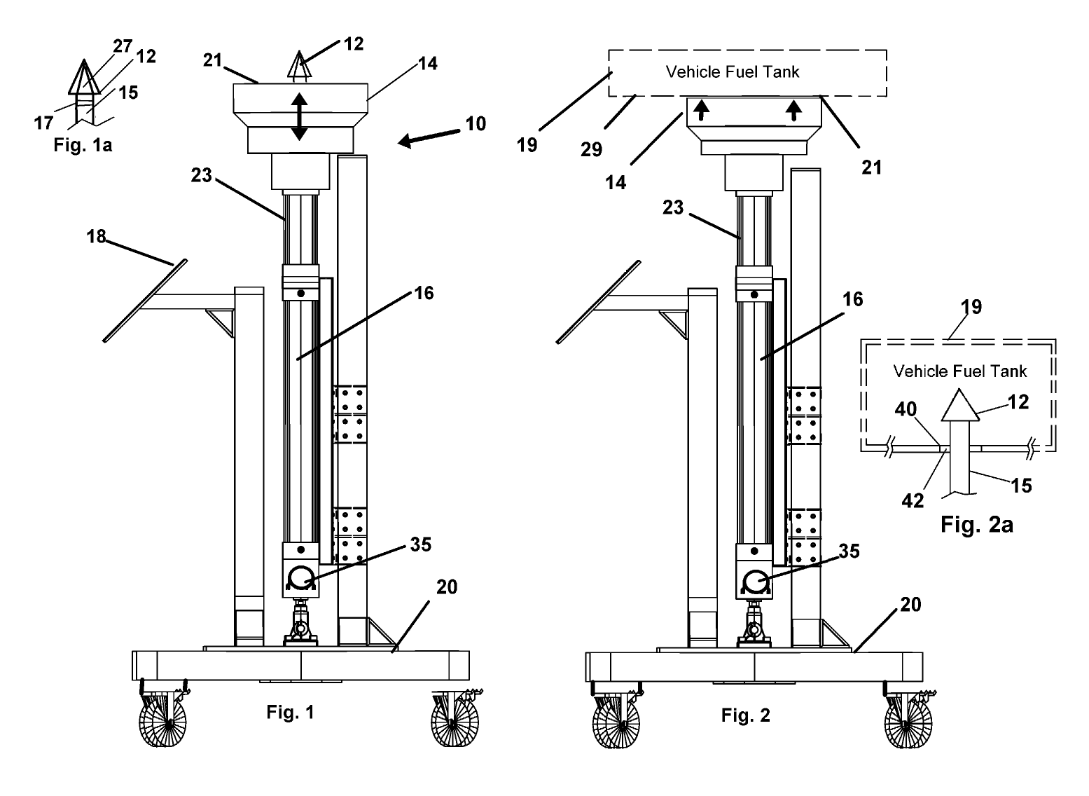

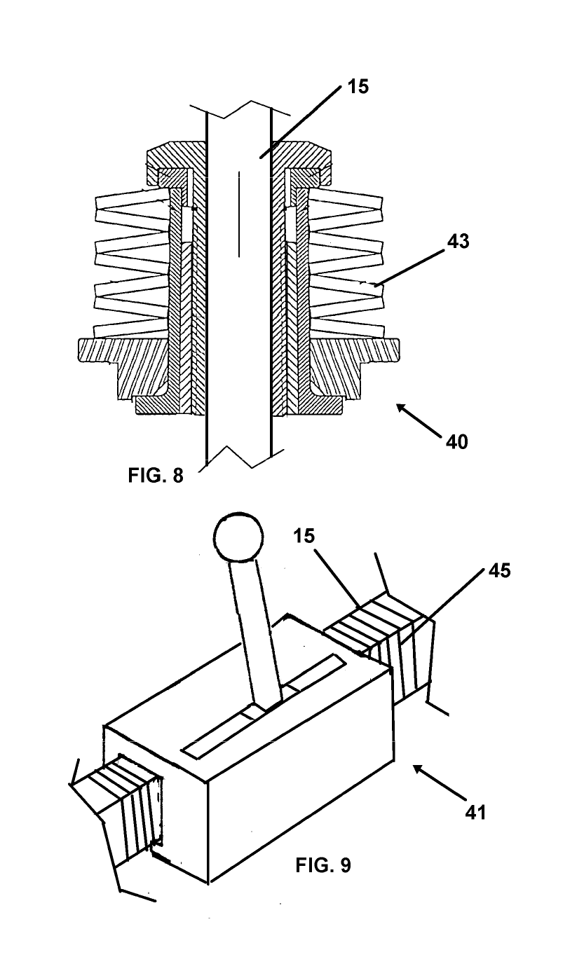

Referring now to the drawings of FIGS. 1-9, wherein similar components are identified by like reference numerals, which may appear in one or multiple drawings, there is seen in FIGS. 1-2 and 6-7 modes of device 10 which are employable for accessing and draining the interior of vehicle fuel tanks during the wrecking or reclaimation process of the vehicle. The device 10 is configured with piercing spear member 12 engaged to a hydraulicly or otherwise powered shaft member 15 having an axial passage 31 (FIG. 4) running therethrough. The shaft member engaged to a hydraulic or otherwise power communicating device, is translated within a surrounding funnel member 14. Translation of the shaft member to effectuate a piercing of the fuel tank 19, through the employment of means for powered translation such as a hydraulic cylinder component 16 using fluid or gas for generating hydraulic power, or by spring loaded (FIG. 8) or lever-powered (FIG. 9) components or other means for powered translation of the shaft member 15 through the tank wall. The fluid powered cylinder 16 if employed is of conventional construction and is powered by a pumping of gas or hydraulic fluid as a hydraulic powered means to gain mechanical advantage and force.

The engagement of the spear 12 onto the shaft member 15 if employed may be permanent, or in an especially preferred mode, may be accomplished using means for removable engagement such as with a threaded engagement 17.

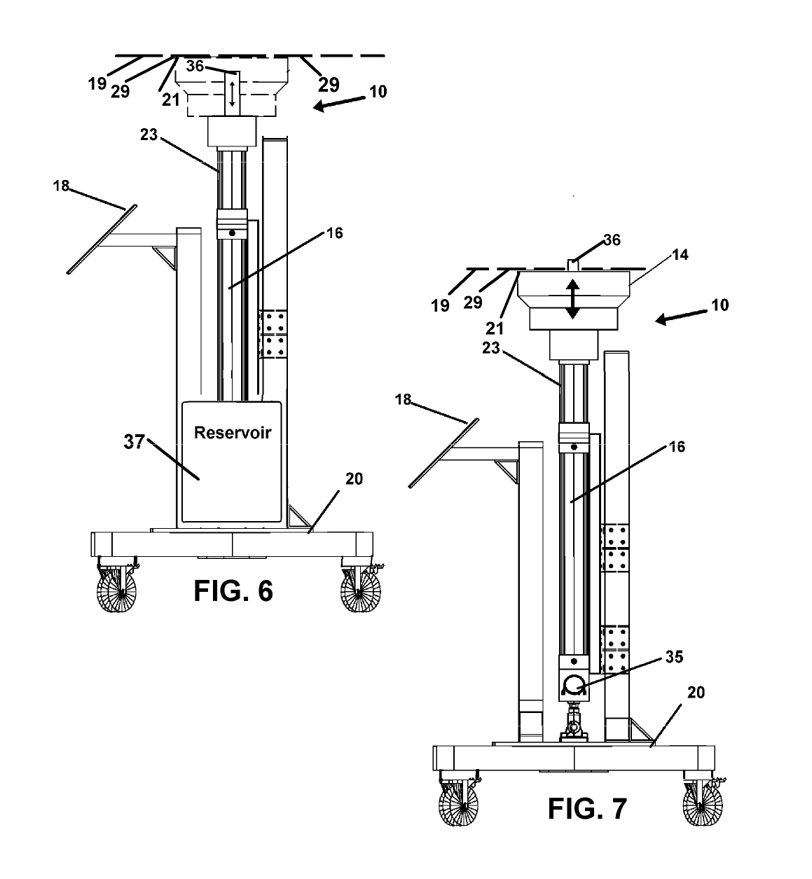

In one particular mode of the device 10 as depicted on a rolling cart 20 of 1-2 and 6-7, a control display area having a controller 18 is also depicted to allow the user to activate and control translation of the translation of the shaft member 15 and/or spear 12 by controlling the translation of the operatively engaged powered cylinder 16 to provide the force and movement to shaft member 15 for a piercing of the fuel tank 19 The powered cylinder 15 providing the force to the translating shaft member 15 yields sufficient force and capacity to translate the shaft member 15 whereby it easily punctures a conventional metal or plastic vehicle fuel tank 19. Similarly the rolling cart system 20 is of appropriate material and construction to withstand the vertical forces necessary for puncture, and withdrawal of the spear 12. As depicted in FIG. 6, a reservoir 37 may be operatively mounted thereon.

A view of the draining position of the device 10 from the pre-deployment position of FIGS. 1 and 6, shows the translation of the shaft member 15 or spear 12 to an engaged position of FIGS. 2 and 7. The shaft member 15 with spear member 12 in FIG. 2, and the translated shaft member shown in FIG. 7, both in the draining position, are fully penetrated into a vehicle fuel tank 19. Residual fuel in the fuel tank 19, once so punctured, will drain around and/or through an aperture 27 in the spear 12 engaged with or through the axial passage 31 in the hydraulic shaft member 15 such as in FIG. 7.

The surrounding funnel component 14, may be formed of resilient material such as plastic or rubber at its leading edge 21, so as to form a means for sealing against the bottom surface 29 of the fuel tank 19 and to catch draining fuel and liquid, and, to keep fuel and liquid which might cling to the exterior or bottom surface 29 of the fuel tank 19, from communicating outside the seal formed by the leading edge 21 of the funnel component 14. However, because the funnel component 14 has a circumference spaced a distance from the centered spear 12 and member 15, it will in normal circumstances, or when employed for fuel tanks 19 having uneven lower surfaces, adequately catch and contain all fuel drained. As such it is envisioned, the device 10 may employ the funnel component 14 in both positions depending on the user's decision on how far to translate the spear 12 or shaft 15 into the fuel tank 19. Further, if employed in a non contact manner with the fuel tank 19 as a regular course of use, the funnel component 14 may be formed of less resilient material such as hard plastic or metal, or may simply have a resilient seal affixed to its distal edge.

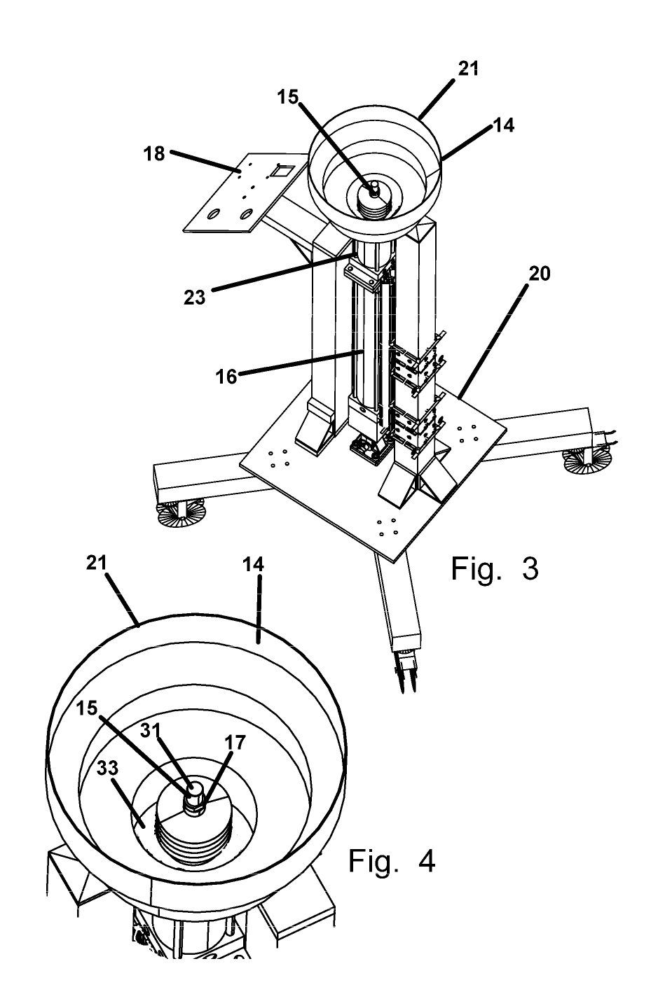

As can be seen in FIGS. 3 and 4, the distal end of the shaft member 15 may be adapted for removable engagement of a spear 12 so as to allow replacement. Alternatively, the spear 12 may be engaged permanently to the shaft member 15 and both replaced as needed. However, if the spear 12 is removably engageable, it will allow the user to replace the spear 12 when worn, or replace the spear 12 from a kit of different sized and configured spears 12 so as to customize the device 12 to the job at hand. If in a kit, some spears 12 could have larger diameters at their widest point, and some smaller, along with other elements of customization. Additionally, as shown in the operation of FIG. 6-7, the hydraulic shaft 15 may translate independently of the funnel component 14 or concurrently through the employment of a second cylinder 16 operatively engaged to translate the exterior shaft member 23 coaxially engaged with the shaft member 15. The controls noted in FIGS. 1-3 would be adapted for dual control and thereby allow the seal to be accomplished as in FIG. 6, before or after a piercing of the tank 19 by shaft 15 or the spear as in FIG. 2a.

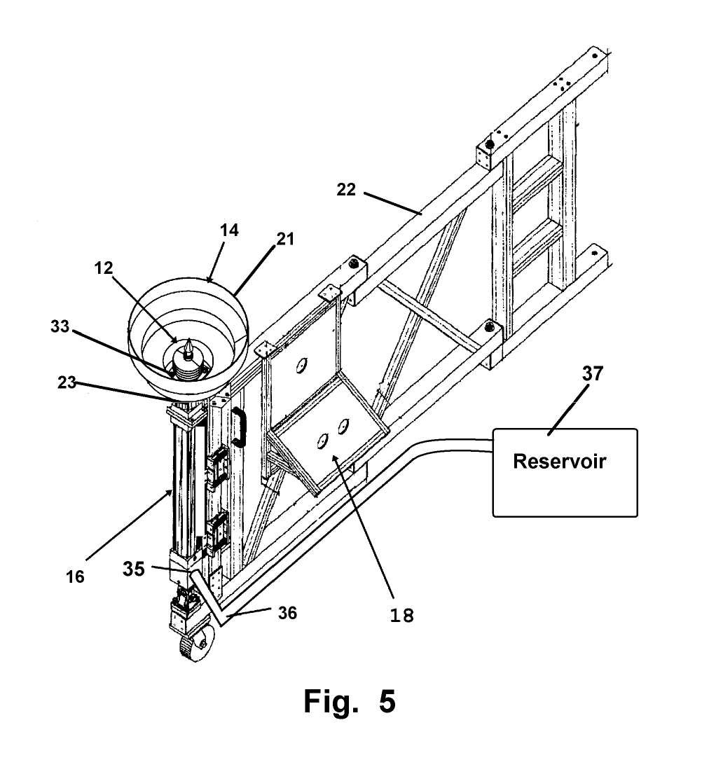

Drainage and communication of fuel from the interior of the tank 19 is accomplished through a drain conduit such as a pipe or hose 36 which at a first end is in sealed communication with one or both of an axial passage 31, shown in FIGS. 4 and 6 and 7, and drain passage 33 communicating with the base of the funnel component 14 through the axial passage 31 of shaft member 15. At a second end the hose 36 is in sealed communication to a reservoir 37 (FIGS. 5-6). An exit aperture 35 in fluid communication with the axial passage 31 and funnel component 14, is shown in FIGS. 2 and 7, as a current means for communicating fuel collected from the tank 19, to the hose 36 or other conduit, leading to the reservoir 37 which would also be of conventional construction such as a drum or tank.

While the rolling cart mode of the device 10 of FIGS. 1-2 and 6-7 is easily deployed, another mode of disclosed device 10 is seen in FIG. 5 where components are engaged upon a fixed wall mounted system 22. Again the display control center 18 is depicted as part of the mounting system 22. Wall mount system 22 is of such material and construction to allow for rotational swinging of the device 10 from a stored position against a wall, to one underneath a raised vehicle easily and safely and can withstand all forces necessary to complete such actions.

FIG. 8 shows a mode of a means for imparting force to the shaft member 15 spring loaded component 40 employable to force the shaft member 15 through the fuel tank 19 wall. A trigger would be engaged to allow retraction of the shaft member 15 and compression of the spring 43 loaded component 40. Release of the trigger (not shown) would impart the stored energy to the shaft member 15 from the spring 43.

FIG. 9 depicts a geared component 42 employable to impart the driving force to the shaft member 15 and power it through the tank wall. A geared interface 45 is engaged with the shaft member 15 and internal gearing of the geared interface 45 would provide mechanical advantage to impart sufficient force to the shaft member 15 to pierce the wall of the fuel tank 19 (FIGS. 6 and 7). The geared interface 45 and the spring loaded component 40 are just two of other means to achieve the force to drive the shaft member 15 with sufficient force to pierce the wall of the fuel tank 19 and those skilled in the art will realize that these means to gain mechanical advantage, as well as the pump driven fluid with a cylinder 16, are but a few of the noted powered means to drive the shaft member 15 at a force sufficient to pierce the tank 19 wall. An electric powered solenoid (not shown) is another well known device which may be employed. Consequently one or a combination of a group of powered components for translation, including a pump communicating fluid under pressure to a cylinder, an electrically powered solenoid, a user-triggerable spring loaded component, and a geared component achieving mechanical advantage with gearing between a lever and the translating member 15, can be employed to impart the power to translate the member 15 and drive it though the wall of the fuel tank. Further, those skilled in the art, after reading this disclosure, will discern other powered means for driving the translation of the member 15. As such, any component to impart such force to pierce the fuel tank wall with the distal end of the member 15, as would occur to those skilled in the art, is anticipated within the scope of this invention.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. An apparatus for removal of residual fuel from a vehicle fuel tank positioned above said apparatus, comprising:
means for forming a puncture in a wall defining an interior cavity of said fuel tank holding fuel therein;
means to translate said means for puncturing along an axis, at a force sufficient to achieve said puncture;
said puncture defining an aperture in said wall;
means to capture said fuel exiting said interior cavity through said aperture; and
a conduit in sealed communication between said means to capture said fuel, and a reservoir, whereby said fuel exiting said interior cavity is captured and communicated to said reservoir through said conduit.

2. The apparatus for removal of residual fuel of claim 1, wherein said means for forming a puncture comprises:
an elongated member having a distal end and a proximal end; and
an axial passage communicating between said distal end and said proximal end.

3. The apparatus for removal of residual fuel of claim 2, additionally comprising:
said means to capture said fuel comprising said axial passage; and
said proximal end of said axial passage in sealed communication with said conduit, whereby said fuel exiting said interior cavity travels through said axial passage to said conduit and to said reservoir.

4. The apparatus for removal of residual fuel of claim 2, additionally comprising:
a seal, said having a first end, and having a leading edge opposite said first end;
said seal having a sidewall communicating between said leading edge and said first end, said sidewall defining a body, said sidewall of said body surrounding said elongated member positioned along said axis; and
a sealed communication between said first end of said seal and said conduit, whereby any said fluid communicating around said axial passage and through said aperture is collected within said body of said seal and communicated to said reservoir.

5. The apparatus for removal of residual fuel of claim 2, wherein said means to translate said means for puncturing along said axis comprises:
one or a combination of powering components from a group including a cylinder driven by compressed pressurized gas or fluid, a spring loaded component triggerable by a user, a lever engaged with geared component configured for mechanical advantage, and an electrically powered solenoid.

6. The apparatus for removal of residual fuel of claim 3, wherein said means to translate said means for puncturing along said axis comprises:
one or a combination of powering components from a group including a cylinder driven by compressed pressurized gas or fluid, a spring loaded component triggerable by a user, a lever engaged with geared component configured for mechanical advantage, and an electrically powered solenoid.

7. The apparatus for removal of residual fuel of claim 4, wherein said means to translate said means for puncturing along said axis comprises:
one or a combination of powering components from a group including a cylinder driven by compressed pressurized gas or fluid, a spring loaded component triggerable by a user, a lever engaged with geared component configured for mechanical advantage, and an electrically powered solenoid.

8. The apparatus for removal of residual fuel of claim 3 additionally comprising:
a spear having a leading edge and an engagement end opposite thereto;
said spear having a conical shape extending from a wider end at said engagement end to a narrower end at said leading edge;
said engagement end configured for attachment to said distal end of said elongated member; and
a fluid path communicating between said leading end to said engagement end for communication of said fluid to said axial passage.

9. The apparatus for removal of residual fuel of claim 6 additionally comprising:
a spear having a leading edge and an engagement end opposite thereto;
said spear having a conical shape extending from a wider end at said engagement end to a narrower end at said leading edge;
said engagement end configured for attachment to said distal end of said elongated member; and
a fluid path communicating between said leading end to said engagement end for communication of said fluid to said axial passage.

10. The apparatus for removal of residual fuel of claim 4 additionally comprising:
said seal translatable from a retracted position to an extended position;
said seal in said extended position forming a seal between said leading edge of said seal, and an exterior surface of said fuel tank; and
said seal translatable to said extended position, prior to said translation of said elongated member to achieve said puncture, whereby said seal is positionable to collect any said fluid leaking through said aperture between said aperture and said distal end of said elongated member communicating therethrough subsequent to said puncture.

11. The apparatus for removal of residual fuel of claim 7 additionally comprising:
said seal translatable from a retracted position to an extended position;
said seal in said extended position forming a seal between said leading edge of said seal, and an exterior surface of said fuel tank; and
said seal translatable to said extended position, prior to said translation of said elongated member to achieve said puncture, whereby said seal is positionable to collect any said fluid leaking through said aperture between said aperture and said distal end of said elongated member communicating therethrough subsequent to said puncture.

12. The apparatus for removal of residual fuel of claim 4 additionally comprising:
said apparatus engaged atop a wheeled base, and
said apparatus being rollable to positions beneath said fuel tanks for a draining thereof.

13. The apparatus for removal of residual fuel of claim 5 additionally comprising:
said apparatus engaged atop a wheeled base, and
said apparatus being rollable to positions beneath said fuel tanks for draining thereof.

14. The apparatus for removal of residual fuel of claim 6 additionally comprising:
said apparatus engaged atop a wheeled base, and
said apparatus being rollable to positions beneath said fuel tanks for draining thereof.

15. The apparatus for removal of residual fuel of claim 7 additionally comprising:
said apparatus engaged atop a wheeled base, and
said apparatus being rollable to positions beneath said fuel tanks for draining thereof.

16. A method for reclaiming fuel from vehicle fuel tanks employing the device of claim 11 using the steps of:
translating said leading edge of said seal to said extended position;
translating said elongated member to puncture said tank and position said distal end of said member through said aperture; and
communicating said fluid flowing through said axial passage and collected within said body of said seal, through said conduit to said reservoir.

17. A method for reclaiming fuel from vehicle fuel tanks employing the device of claim 15 using the steps of:
rolling said apparatus underneath a fuel tank,
translating said leading edge of said seal to said extended position;
translating said elongated member to puncture said tank and position said distal end of said member through said aperture; and
communicating said fluid flowing through said axial passage and collected within said body of said seal, through said conduit to said reservoir.
